(19) United States
(12) Patent Application Publication
(10) Pub. No.: US 2003/0137130 A1
(43) Pub. Date: Jul. 24, 2003

(54) Wheel receiving device for baby sleeping bed

(75) Inventor: Hui-Tsang Chang, Hsin-Chu Industrial Park (TW)

Correspondence Address: LOWE HAUPTMAN GILMAN AND BERNER, LLP, 1700 DIAGONAL ROAD, SUITE 300 /310, ALEXANDRIA, VA, 22314, US

(73) Assignee: KINGSTAR BABY CARRIAGE CO., LTD.

(21) Appl. No.: 10/053,591

(22) Filed: Jan. 24, 2002

(51) Int. Cl. B62B 3/02; B62B 9/22

(52) U.S. Cl. 280/641; 280/43.24

(57) ABSTRACT

The present invention relates a wheel receiving device for utilizing in a baby sleeping bed. The wheel receiving device includes a housing, a locating rotor, a wheel and a latch. The locating rotor is rotatable and mounted inside the housing/the latch is passing a spring and then fixed with a push bottom. There is a pin for securing said locating rotor at a first position that the wheel is capable to move, especially exposed out the housing. The locating rotor is further capable to be shifted from the first position to a second position. In this case, the locating rotor is secured and the wheel is stopped and not capable to move.

### BACKGROUND OF THE INVENTION

1. Field of the Invention

The present invention generally relates to a wheel receiving device, especially to the wheel receiving device for utilizing in a baby sleeping bed.

2. Background Description

Since the city is urbanized, the living space is therefore reduced for the urbanites. The housing and the housing supplies and devices are developed toward multifunction in order to save the spaces. The baby sleeping bed is reduced the size in this consideration.

For instance, the baby sleeping bed only with the feature of rocking function is very popular in the past years. The manufacturers have now provided a baby sleeping bed with the functions of rocking and the ability of receiving the wheels on the market. However, the present baby sleeping bed with the feature of receiving wheels is simply providing a rotatable axis for rotating the wheels to the receiving portion and then plug a pin to fix the wheels. This kind of mechanism solves the demanding needs of the baby sleeping bed but the use is not safe and convenient.

In view of the above, the present invention provides a wheel receiving device which makes the movement of baby sleeping bed easily. Mostly, after wheels are received, the baby sleeping bed can have the rocking function.

### SUMMARY OF THE INVENTION

It is therefore an object of the present invention to provide a baby sleeping bed having a wheel receiving device with the benefits of east of use, strengthened structure, high durability and east assembly.

### BRIEF DESCRIPTION OF THE DRAWINGS

The foregoing and other objects, aspects and advantages will be better understood from the following detailed description of a preferred embodiment of the invention with reference to the drawings, in which:

FIG. 1 shows the present invention in using status;

FIG. 2 is the side view of the present invention demonstrating the wheel received status;

FIG. 3 shows detailed assembling demonstration of the present invention;

FIG. 4A shows the perspective drawing of the present invention in the using status;

FIG. 4B shows the perspective drawing of the present invention in receiving the wheels; and

FIG. 4C shows the perspective drawing of the present invention in the wheel received status.

### DETAILED DESCRIPTION OF A PREFERRED EMBODIMENT OF THE INVENTION

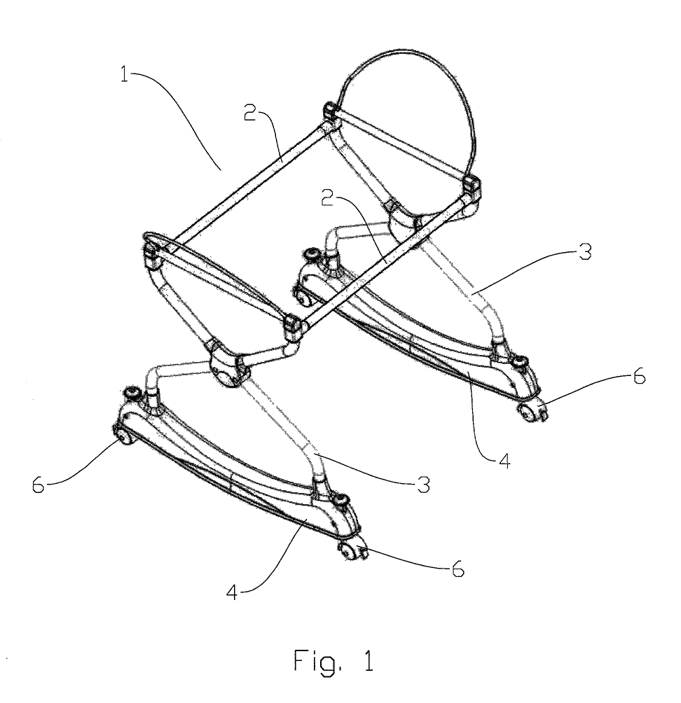

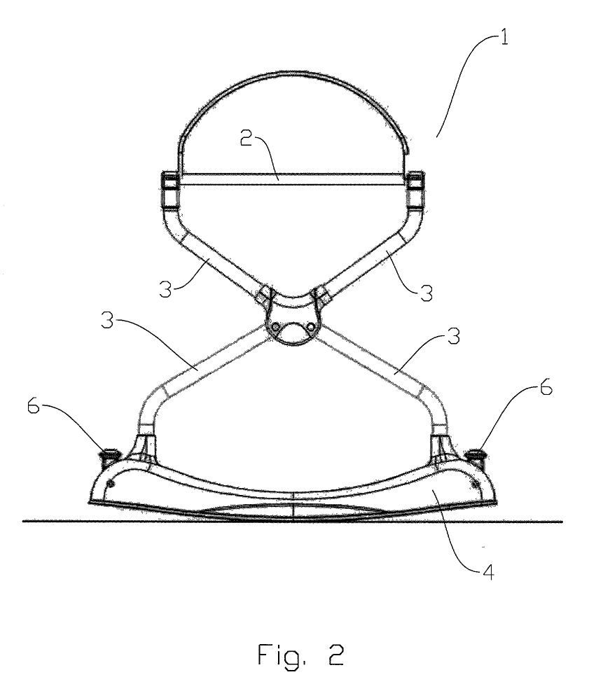

Please refer to the FIG. 1, the baby sleeping bed 1 includes a main frame 2 for mounting a baby pad (not shown), a plural of supporting shafts 3 positioned beside the baby sleeping bed 1 for supporting the bed, a pair of stands 4 connected to the supporting shafts 3. Further refer to FIG. 2, the wheel receiving device 6 is connected to the stand 4. There are two statuses of the wheel receiving device. The first instance is that the wheel is planked out of the stand 4. In this case, the baby sleeping bed is movable around the house by the users. However, as shown in FIG. 1, when the wheel is received in the stand 4 by the help of the wheel receiving device. The wheels are not able to be employed to move the baby sleeping bed. Thus, the baby sleeping bed has the feature of rocking function.

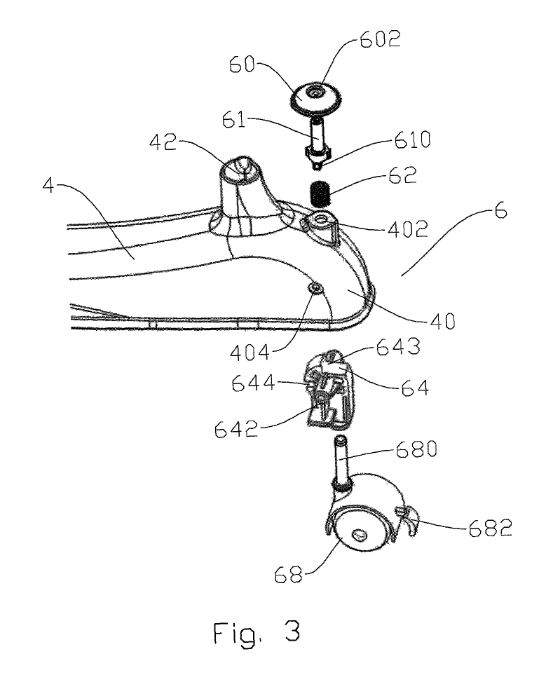

FIG. 3 demonstrates the detailed assembling of the wheel receiving device 6. The wheel receiving device 6 has a housing 40, a locating rotor 64, wheel 68 and a fixation latch 61. The housing 40 is extended form the stand 4 and further contains a fixation hole 42 for mounting on said supporting shaft 3. The housing may also be independent from the stand. The locating rotor 64 has an axis hole 642 for attaching to a hole 404 of the housing 40 by a latch (not shown). In this case, the locating rotor 64 is able to rotate around the latch. Locating rotor 64 further comprises a first positioning hole 643 and a second positioning hole 644. Moreover, there is a wheel support 680 for supporting the wheel 68 and the locating rotor 64. The wheel 68 also has a braking bar 682 for stopping the rotation of the wheel 68. When the braking bar 682 is pushed down, the wheel is secured and cannot move. The fixation latch 61 is passing a spring 62 to the hole 402 of the housing 40, in order to connect a push bottom 60. There is able to set a screw (not shown) to mount the push bottom 60 with the latch 61. In this case, the spring provides a restoring force to the latch 61. There may be further designed a pin 610 to fix the position of the locating rotor 64.

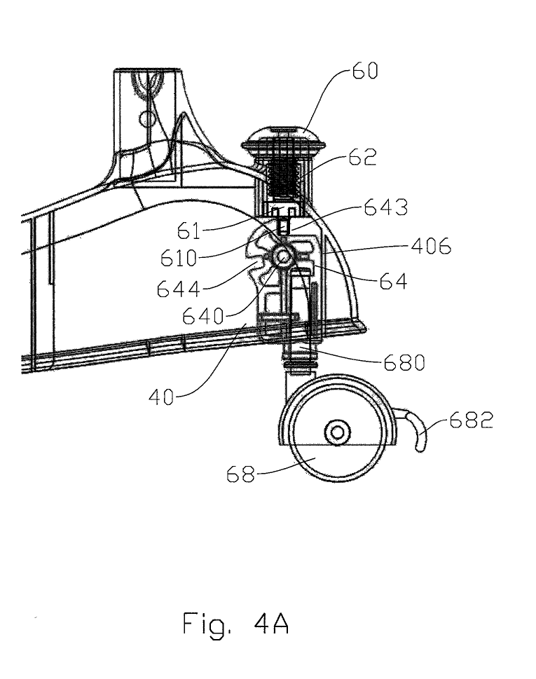

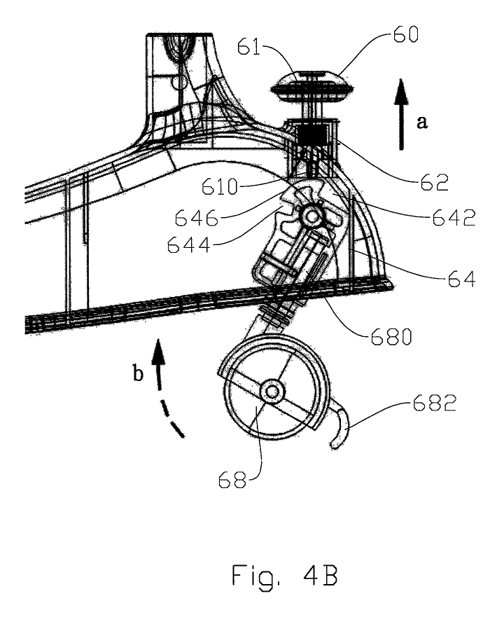

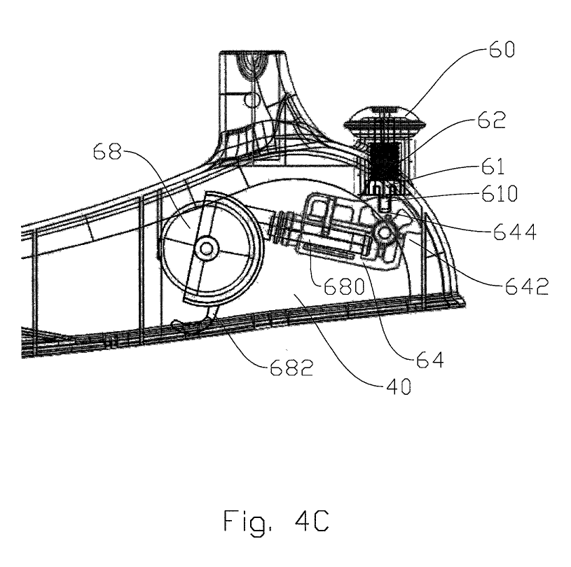

For further detailed description of the present invention, please see FIGS. 4A, 4B and 4C. FIG. 4A shows the perspective drawing of the present invention in using status. Since the latch 61 is against the inner surface of the housing 40, the latch 61 is therefore moved downwardly by the help of the spring 62. In this case, the pin 610 is inserted to the first position hole 643. The locating rotor 64 attaches the separation wall 406 of the housing 40 and is fixed in a first position. As shown in the FIG. 4A, the wheel 68 is exposed out of the housing 40 and capable to convey the baby sleeping bed 1 around the house if needed.

If the user would receive the wheel 68, the user is needed to hold and pull the push bottom 60. In this case, the latch 61 is pulled together as shown in FIG. 4B. Once the pin 610 is away from the first positioning hole 643 of the rotor 64, the wheel 68 is able to be moved along with the rotor 64 as shown of the arrow b in FIG. 4B. In this case, push bottom 60 is allowed to be released and the pin 610 of the latch 61 will contact the curve surface 646 of the rotor 61 by the reaction of spring, until the wheel 68 is rotated to a receiving place as shown in FIG. 4C. The pin 610 will therefore be inserted into the second positioning hole 644 of the rotor 64. The wheel is received in a second position that the wheel 68 is in a receiving status. Since lower portion of the supporting shaft 4 is curve, the baby sleeping bed is able to provide the rocking feature to comfort the baby.

For the reversing consideration, the user pulls the push bottom 60 to shift the rotor 64 from the second position to the first position as mentioned in the above.

As disclosed in the above, the wheel receiving device 6 of the present invention will provide a convenient way for parents to shift the baby sleeping bed from portable status to the rocking status. Since the pin 610 is utilized, the baby sleeping bed is able to be secured between and at the two statuses of portable and rocking features. Furthermore, the employment of the push bottom is designed to meet user's instinct for operation and therefore reaching the requirement of user friendly interface.

Although preferred embodiments of the present invention have been described in the forgoing description and illustrated in the accompanying drawings, it will be understood that the invention is not limited to the embodiments disclosed, but is capable of numerous rearrangements, modifications, and substituting of parts and elements without departing from the spirit and scope of the invention. Accordingly, the present invention is intended to encompass such rearrangements, modifications, and substitutions of parts and elements as fall within the scope of the appended claims.

1. A wheel receiving device for a baby sleeping bed, comprising:
a housing;
a locating rotor, rotatable and positioned in said housing;
a wheel connected to said locating rotor; and
a latch, positioned through said housing and connected to a push bottom, having a pin for inserting to a first positioning hole to secure said locating rotor at a first position, and inserting to a second positioning hole to secure said locating rotor at a second position.

2. The wheel receiving device of claim 1, wherein said locating rotor comprises at least an axis hole for mount said locating rotor to said housing by an axis shaft.

3. The wheel receiving device of claim 1, wherein said wheel comprises at least a wheel support for connecting said wheel to said locating rotor.

4. The wheel receiving device of claim 1, wherein said wheel comprises a braking bar for stopping the movement of said wheel.

5. The wheel receiving device of claim 1, wherein said locating rotor comprises a spring, attaching to said locating rotor, for providing a restoring force.

6. The wheel receiving device of claim 1, wherein said wheel is rotatable at said first position since the wheel is exposed out of said housing.

7. The wheel receiving device of claim 1, wherein said wheel is sopped at said second position since the wheel is received inside said housing.

8. The wheel receiving device of claim 1, wherein said latch and said push bottom is fixed by a screw.

9. The wheel receiving device of claim 1, wherein said supporting shaft comprises a lower portion with curved shape.
